(19) United States
(12) Patent Application Publication
(10) Pub. No.: US 2025/0244040 A1
(43) Pub. Date: Jul. 31, 2025

(54) SYSTEM AND METHOD FOR CONTROLLING HOUSE HVAC LOAD USING VEHICLE TO HOUSE POWER SYSTEM

(71) Applicant: Ford Global Technologies, LLC, Dearborn, MI (US)

(72) Inventors: Jonathan Hair, Northville, MI (US); Matthew Penne, Pierce, NE (US)

(21) Appl. No.: 18/423,585

(22) Filed: Jan. 26, 2024

(51) Int. Cl. F24F 11/65; B60L 55/00; F24F 11/46

(52) U.S. Cl. CPC F24F 11/65; B60L 55/00; F24F 11/46

(57) ABSTRACT

A method for supplying electrical power from a vehicle to a building having a heating, ventilation, air conditioning (HVAC) system includes detecting an unrestricted power load that is indicative of an unrestricted power output requested by the HVAC system having a plurality of HVAC devices, and selectively controlling, in accordance with a restricted HVAC schedule defined in response to the unrestricted power load being greater than a vehicle-to-building (V2B) power threshold, one or more HVAC device from among the plurality of HVAC devices at a restricted power load that is less than the unrestricted power load to have at least one HVAC device from among the one or more HVAC devices controlled at a restricted power limit.

### TECHNICAL FIELD

The present disclosure relates to providing power to a heat, ventilation, and air conditioning system of a building employing electric power from a vehicle.

### BACKGROUND

The statements in this section merely provide background information related to the present disclosure and may not constitute prior art.

Increasing energy prices can be related to traditional resources, such as coal and gas, being phased out due to environmental concerns while clean energy sources are gradually being implemented. In addition, with the move to electrified vehicles (EVs) having high power battery packs, the demand for electric power may also be on the rise further increasing the price of energy. In some communities, electric power is maintained at a flat rate regardless of the demand, whereas other communities have implemented dynamic rates that change based on various factors, such as supply and demand. For example, during the summer in Texas, electric power may be cheaper between late night and early morning hours (e.g., 10:00 pm-4:00 am) than between the afternoon and early evening hours (e.g., 12:00 pm to 6:00 pm) due to the demand of powering HVAC systems. Smart thermostats have been employed in residential and commercial buildings to efficiently control of the HVAC system by activating the system when needed, and EVs are charged during lower power rates.

### SUMMARY

This section provides a general summary of the disclosure and is not a comprehensive disclosure of its full scope or all of its features.

In one form, the present disclosure is directed to a method for supplying electrical power from a vehicle to a building having a heating, ventilation, air conditioning (HVAC) system. The method includes detecting an unrestricted power load that is indicative of an unrestricted power output requested by the HVAC system having a plurality of HVAC devices, and selectively controlling, in accordance with a restricted HVAC schedule defined in response to the unrestricted power load being greater than a vehicle-to-building (V2B) power threshold, one or more HVAC device from among the plurality of HVAC devices at a restricted power load that is less than the unrestricted power load to have at least one HVAC device from among the one or more HVAC devices controlled at a restricted power limit.

In one form, the present disclosure is directed to a vehicle-to-building (V2B) system for supplying electrical power from a vehicle to a building having a heating, ventilation, air conditioning (HVAC) system. The V2B system including one or more processors, and a memory storing instructions executable by the one or more processors to cause the one or more processors: detect an unrestricted power load that is indicative of an unrestricted power output requested by the HVAC system having a plurality of HVAC devices; and selectively control, in accordance with a restricted HVAC schedule defined in response to the unrestricted power load being greater than a V2B power threshold, one or more HVAC device from among the plurality of HVAC devices at a restricted power load that is less than the unrestricted power load to have at least one HVAC device from among the one or more HVAC devices controlled at a restricted power limit.

In one form, the present disclosure is directed to a non-transitory computer-readable medium comprising instructions for supplying power electrical power from a vehicle to a building having a heating, ventilation, air conditioning (HVAC) system that, when executed by a vehicle-to-building (V2B) system, cause the V2B system to perform operations including to: detect an unrestricted power load that is indicative of an unrestricted power output requested by the HVAC system having a plurality of HVAC devices; and selectively control, in accordance with a restricted HVAC schedule defined in response to the unrestricted power load being greater than a V2B power threshold, one or more HVAC device from among the plurality of HVAC devices at a restricted power load that is less than the unrestricted power load to have at least one HVAC device from among the one or more HVAC devices controlled at a restricted power limit.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a building having vehicle-to-building (V2B) system in accordance with the present disclosure;

FIG. 2 is a block diagram of a smart heating, ventilation, and air-conditioning (S-HVAC) system of the building in accordance with the present disclosure;

FIG. 3 is a block diagram of the V2B system in accordance with the present disclosure;

FIG. 4 is a flowchart of a HVAC management routine in accordance with present disclosure;

FIG. 5A is an example graph illustrating power load of a building without a restricted HVAC schedule; and

FIG. 5B is an example graph illustrating power load of a building with the restricted HVAC schedule in accordance with the present disclosure.

The drawings described herein are for illustration purposes only and are not intended to limit the scope of the present disclosure in any way.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some electrified vehicles (EVs) having a rechargeable battery pack, such as a plug-in hybrid or fully electric vehicle, may be used to provide power to a building. In a non-limiting example, an EV may be used to supply power to a house using bidirectional energy transfer as part of a vehicle-to-building (V2B) system (also known as “vehicle-to-house (V2H) system”). In some instances, the amount of energy that the EV may supply is limited, and thus, not all electrical devices of the house including high power HVAC devices of the house may be powered.

In one form, the present disclosure is directed to a V2B system for controlling a HVAC system of a building, such as a house, using power from an EV based on, at least, a V2B power threshold and power requirements of the HVAC devices. If the HVAC devices use more power than the V2B power threshold, the V2B system defines a restricted HVAC schedule that controls one or more of the HVAC devices at a restricted power level, such that total power load of the HVAC devices is less than or equal to the V2B power threshold. In a non-limiting example, the restricted HVAC schedule is defined to allow selected HVAC devices to be ON in a staggered approach to provide conditioning of the environment within the building without drawing power from the power grid or reducing the amount of power drawn from the power grid.

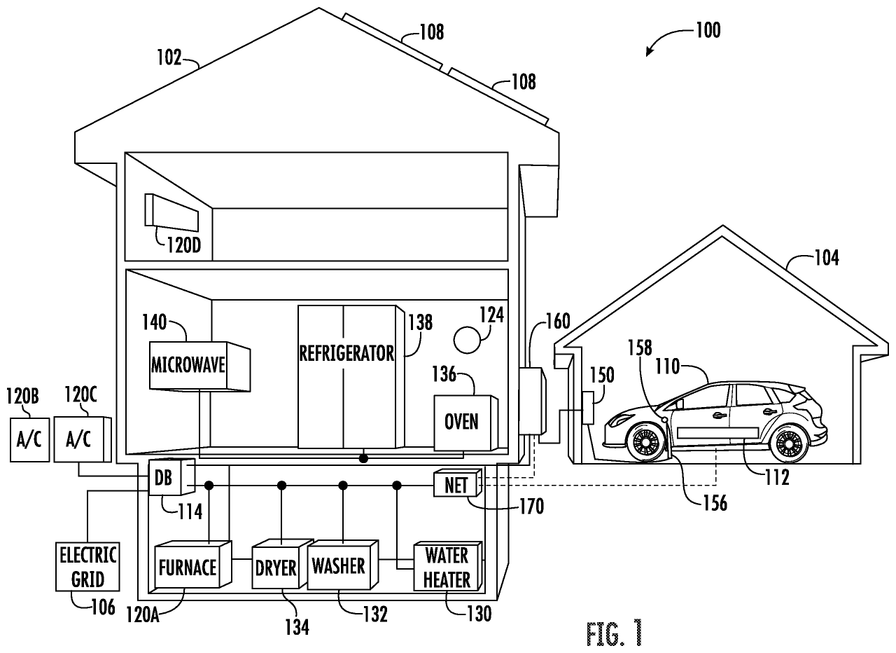

In one form, referring to FIG. 1, a building 100, such as a house 102 having a garage 104, generally receives power from an electrical power grid 106 supported by a utility company. The house 102 may also receive power for other sources, such as solar panels 108 and, as detailed herein, from an EV 110 having a battery pack 112. Other power sources may include a backup generator that runs on natural gas or other fuel.

The power sources, such as the solar panels 108 and the power grid 106, may be electrically coupled to a home power network through a distribution box (DB) 114. The distribution box 114 may provide an attachment point for conductors of the electrical grid 106 and provide connection points for conductors that are routed throughout the house 102 and garage 104 to provide electrical power.

The house 102 generally includes various devices that use electrical power to operate, and these devices are commonly referred to as a load or electrical load. Some of the highest power consuming devices are heat, ventilation, and air-conditioning (HVAC) devices for an HVAC system of the house 102, and may include, but is not limited to: a furnace 120A, air-conditioning units 120B, 120C, and a heat pump 120D (collectively “HVAC devices 120”). As detailed herein, the HVAC devices 120 may work in conjunction with a thermostat 124 that is configured as a user interface to receive HVAC setpoints and display information related to the HVAC system. In one form, the HVAC device 120 may be configured heat/cool different areas of the house 102, thereby forming different HVAC zones within the house 102. In a non-limiting example, a second floor of the house 102 may be a first zone and a first floor of the house 102 is a second zone. In addition, while one thermostat 124 is illustrated, the house 102 may include multiple thermostats configured to control operation of different HVAC devices 120.

In addition to the HVAC devices, the house 102 includes other devices using electrical power, such as but not limited to: a water heater 130, a washer 132, a dryer 134, a stove 136, a refrigerator 138, and a microwave oven 140. In the following description, the combined electrical load of devices that are not HVAC devices 120 are generally described as the home load.

Besides the electrical loads fixedly located at the house 102, other devices may draw power from the home power network, such as but not limited to, the EV 110. The EV 110 may plug-in to the home power network using a charge system 150, which may also be referred to as an EV supply equipment (EVSE), arranged in the garage 104. In a non-limiting example, the EV 110 may be a plug-in hybrid vehicle or a full-electric vehicle having the battery pack 112 to provide drive power to move the EV 110. In one form, the charge system 150 may be directly connected to the distribution box 114, and the distribution box 114 may include transfer switches to selectively isolate the power connection between the electrical grid 106 and the charge system 150. The charge system 150 may be a wall charger mounted to a wall and includes a charge cable 156 having a charger 158 that operably connects the charge system 150 to a charge port assembly of the EV 110 for transferring energy between the EV 110 and the house 102.

In one form, the EV 110 is also operable to provide power to the home power network using a vehicle-to-building (V2B) system 160. The V2B system 160 is a bidirectional energy transfer system that provides electrical power to the home power network from the battery pack 112 to support high power load devices, like the HVAC devices 120. For instance, depending on a power transfer direction, the charge system 150 is configured to convert the power to the proper DC or AC specifications. In addition, the V2B system 160 is configured to communicate with a battery controller of the EV 110 via, for example, the charger 158 of the charge system 150. Alternatively, the V2B system 160 may communicate with the battery controller via a wireless communication link. The V2B system 160 is configured to obtain information related to the battery pack 112, such as, but not limited to state of charge, and notify the battery controller when the EV 110 is to undergo a charge operation or provide electrical power.

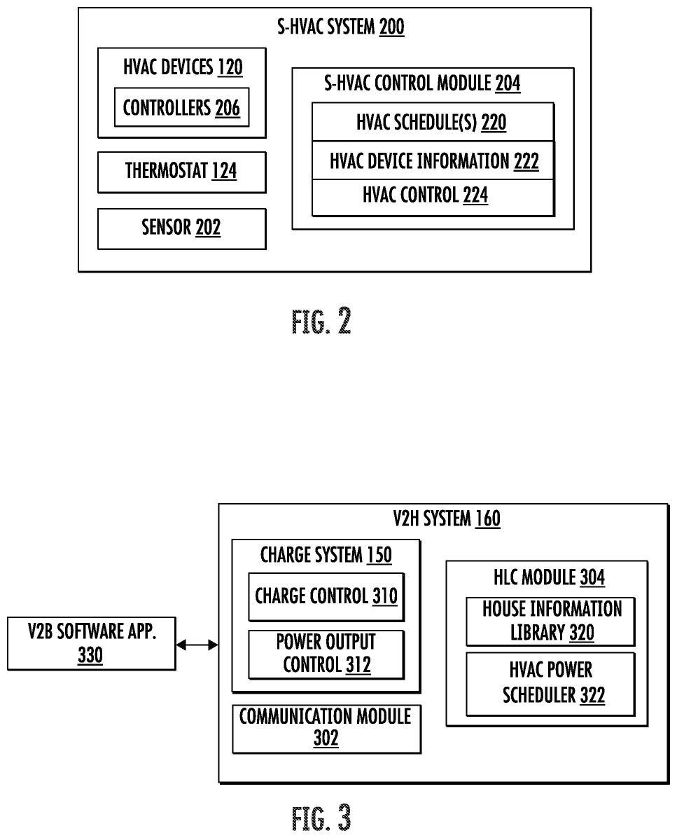

The HVAC system having the HVAC devices 120 are generally configured to control environmental conditions of the house 102 such as, but not limited to, temperature, humidity, and/or air circulation. In one form, referring to FIG. 2, the house 102 has a smart HVAC (S-HVAC) system 200 that includes the HVAC devices 120, the thermostat 124, one or more sensors 202, and a S-HVAC control module 204. The HVAC devices 120, the thermostat 124, and the sensors 202 are in communication with the S-HVAC control module 204 using various communication techniques such as, but not limited to, wireless communication and/or wired communication. In a non-limiting example, the HVAC devices 120 are in communication with the S-HVAC control module 204 via a house communication network 170 (FIG. 1) (e.g., Wi-Fi network). In another example, the S-HVAC control module 204 is disposed with the thermostat 124, and thus, may be directly connected to components of the thermostat 124 forming a smart thermostat. Accordingly, based on the communication technique employed, the HVAC devices 120, the thermostat 124, the sensors 202, and the S-HVAC control module 204 may include various components to support a selected communication technique, such as but not limited to, router, modem, antenna, microprocessor and/or memory.

The HVAC devices 120 generally include a controller 206 configured to control operation of various components within the device 120 for performing a defined HVAC operation. In a non-limiting example, the AC units 120B, 120C may include compressors, a fan, an evaporator, and a condenser, which are controlled by an AC controller to output cool air. In some forms, the AC units 120B, 120C are operable in one mode that draws roughly a defined amount of energy. In some variations, one or more of the AC units 120B, 120C are variable power devices operable at different power levels (e.g., a first power mode or a second power mode that uses less power than the first power mode). It should be readily understood that other HVAC devices 120 may include similar or different components than that of the AC units 120B, 120C, and may be employed by the S-HVAC system 200 in accordance with the present disclosure.

The thermostat 124 is configured to receive inputs from and/or display information to a user/occupant of the house 102. In one form, the thermostat 124 includes user interfaces such as a touch-screen display, one or more dials, and/or an audio system for verbally communicating with the user. In a non-limiting example, the thermostat 124 displays information related to environmental conditions of the house and even outside of the house (e.g., environmental conditions may include temperature, humidity, air flow), information related to HVAC setpoint set by the user (e.g., HVAC setpoints may include temperature setpoint, circulation fan setpoint), and may also indicate an operation mode of the S-HVAC system 200 (e.g., operation mode may include ON, OFF, ECO mode to converse power). The inputs received and information displayed by the thermostat 124 may be provided to or received from the S-HVAC control module 204.

In one form, the sensors 202 are arranged around (e.g., inside and/or outside) to monitor one or more environmental conditions about the house 102. In some applications, one or more sensors 202 maybe provided within the thermostat 124. In a non-limiting example, the environmental conditions may include temperature at one or more locations in/outside the building 100, humidity, and/or dew point.

The S-HVAC control module 204 is configured to control the HVAC devices 120 to satisfy one or more HVAC setpoints for the house 102. In one form, the S-HVAC control module 204 is configured to define one or more HVAC schedules 220 (i.e., building HVAC schedule(s)), store HVAC device information 222, and include a HVAC control 224 that employs various techniques to reach the HVAC setpoints by controlling HVAC devices 120.

More particularly, in one form, the HVAC schedules 220 may define one or more schedules that provide HVAC setpoints for the house 102 for selected days and times. For example, a work week HVAC schedule may be define temperature setpoints for Monday to Friday in which the temperature of the house 102 may be set at higher/lower temperatures from 8:00 am to 6:00 pm since the house 102 if the house 102 is generally unoccupied (e.g., for heat mode, temperature is set to 55° F. to inhibit activation of furnace 120A until temperature of the house 102 is below 55° F. and for cool mode, temperature is set to 85° F. degrees so the air-conditioning units 120B, 120C are not activated until temperature reaches 86° F.). In another example, a weekend HVAC schedule may define temperature setpoints for Saturday and Sunday, which may be different from the work week schedule since the house 102 will likely be occupied throughout the day. Other schedules may also be provided like known ECO schedules that define temperature setpoints that typically consider other factors such as, but not limited to, environmental impact and power rates. The HVAC schedules 220 may be defined by a user using various techniques such as through the thermostat 124 and/or a software application associated with the S-HVAC system and provided on a computing device (e.g., a smart phone or tablet). The HVAC schedules 220 may also be defined by the S-HVAC control module 204 using standard HVAC setpoints that might be adjusted based on user's use of the S-HVAC system 200.

In one form, the HVAC device information 222 is configured to store information related to one or more of the HVAC devices 120 that the S-HVAC system 200 controls. In a non-limiting example, this information may include, but is not limited to, identification information for the device 120, area/zone of the house 102 that the HVAC device 120 conditions, and electrical power drawn by the HVAC device 120, which may also be referred to power load.

The HVAC control 224 is configured to control the HVAC devices 120 using various techniques and based on the HVAC schedule 220, HVAC setpoints, and/or other information such as information from the V2B system 160. In one form, the HVAC control 224 may transmit messages to a selected HVAC device 120 requesting the device 120 to turn-on or turn-off, and if applicable, provide a power mode for variable powered HVAC device(s) 120.

Referring to FIG. 3, among other components, the V2B system 160 includes the charge system 150, a communication module 302, and a house load control (HLC) module 304. As detailed above the charge system 150 is configured to control charge operation of the EV 110 and a power supply operation of the EV 110 in which the EV 110 is configured to provide power to the building 100 or more specifically, the house 102. In FIG. 3, the charge operation is generally noted as a charge control 310 and the power supply operation is generally noted as a power output control 312.

In one form, the communication module 302 is configured to communicate with external devices and systems, such as but not limited to, the S-HVAC system 200. The communication module 302 may establish communication using various communication methods, such as, but not limited to, wired communication and wireless communication (e.g., Wi-Fi, cellular network, and BLUETOOTH). For example, the communication module 302 is configured to communicate with the S-HVAC system 200 via the house communication network 170, which may be a Wi-Fi network. Accordingly, the communication module 302 may include devices such as modem, router, antenna, and/or microprocessor.

In one form, the HLC module 304 is configured to control power to electrical loads of the house 102 based on a V2B power threshold that defines a limit on the amount of power the battery pack 112 of the EV 110 can provide. In one form the HLC module 304 includes a house information library 320 and a HVAC power scheduler 322 that defines a restricted HVAC schedule for controlling operation of the HVAC devices 120.

The house information library 320 is a memory device that stores information related to the house 102 and the electrical loads that may be powered by the EV 110, and more specifically to HVAC devices 120. In non-limiting example, the house information may include, at least one of: number of HVAC devices 120; identification information for the HVAC devices; a power load of each HVAC device 120; HVAC schedule(s) defining HVAC setpoints; home zone priority which priorities zones of the house 102 from highest priority to lowest priority; and/or user tolerance for going over V2B threshold or drawing additional power from the grid 106, which may require additional authorization by the user.

The house information may be provided by the user of the house 102, the S-HVAC system 200, and/or may be learned by the V2B system 160. For example, the V2B system 160 may estimate the power load of each HVAC device 120 by obtaining amount of power being used by the house 102 from a power meter associated with distribution box 114 of the house 102, and then activating and deactivating the HVAC devices 120 one at a time to detect the power increase at the power meter when the HVAC device 120 is ON. The difference between when the HVAC device 120 is ON and OFF provides a power load of the HVAC device 120.

In another example, the user may input information, such as the HVAC schedule or the identification information of the HVAC devices 120 using a V2B software application 330 installed and executed by a computing device, such as a smart phone and/or tablet. The V2B software application 330 provides a series of graphical interfaces that are configured to have the user setup a profile that is used to store information related to the user (e.g., name, contact information, EV information), the house 102 (e.g., number of zones, number of floors, HVAC schedule), and the HVAC devices 120 (e.g., identification information, zone affiliation if applicable, power input, variable modes if applicable), and/or other suitable information (such as HVAC setpoints or power rates). The information gathered by the V2B software application 330 may be stored at the computing device and/or at a remote cloud-based server. In yet another example, the HLC module 304 is configured to retrieve information related to the HVAC devices 120 from web-based resources that may be accessible by the HLC module 304 via the communication module 302.

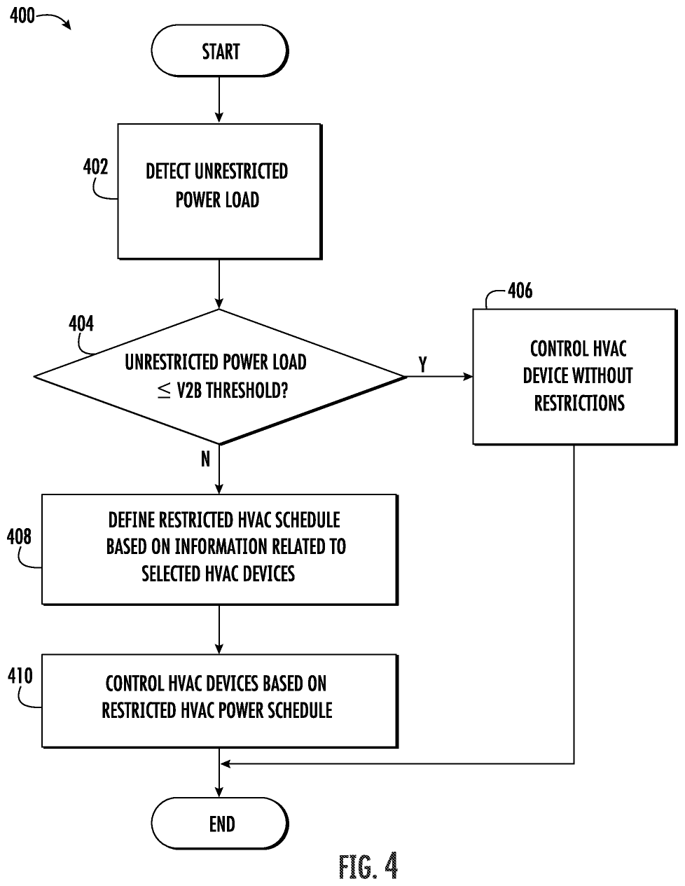

Using the information in the library 320 and the V2B threshold, the HLC module 304 is configured to determine which HVAC devices 120 are to receive power via the EV 110. More particularly, referring to FIG. 4, an example HVAC management routine 400 executed, at least in part, by the HLC module 304 is illustrated. At operation 402, the HLC module 304 is configured to detect an unrestricted power load of the S-HVAC system 200, which is indicative of an unrestricted power output requested by the S-HVAC system 200. That is, with the EV 110 connected to the charge system 150 and selected for the power output control 312 to provide power to the house power network, the HLC module 304 detects the amount of power to be used by the HVAC devices 120 to operate in accordance with the HVAC schedule 220 associated with the current time and day, and/or information from the S-HVAC system 200 indicating the HVAC devices 120 to be ON based on temperature setpoint. In one form, the unrestricted power load is provided as total amount of power required for a set duration (e.g., total power per one hour; total power for two-hrs., etc.), In a non-limiting example, if the S-HVAC system 200 indicates that both AC units 120B, 120C are to be ON and the power load for each AC unit 120B, 120C is 3 kW/hr., the unrestricted power load of the S-HVAC system 200 is detected to be the total power to be supplied to the AC units 120B, 120C, and is 6 kW/hr. In another example, the unrestricted power load is estimated based on the HVAC schedule 220 that indicates when selected HVAC devices 120 are to be ON or OFF and power loads associated with the selected HVAC devices.

Once detected, HLC module 304, at operation 404, determines if the unrestricted power load of the S-HVAC system is equal to or less than the V2B threshold. In one form, the V2B threshold is a value that takes into consideration of the home load, which is the power load associated with non-HVAC devices 120. Accordingly, at operation 404, the V2B threshold may be remaining available power after the home load is considered. If the V2B threshold is greater than the unrestricted power load the HLC module 304 is configured to control HVAC devices 120 without restrictions, at operation 406. Accordingly, in a non-limiting example, if the V2B threshold is 7 kW and the unrestricted power load of the S-HVAC system 200 is 6 kW/hr., then both AC units may be turned ON for approximately an hour.

Alternatively, if the unrestricted power load is greater than the V2B threshold, then the HLC module 304 defines a restricted HVAC schedule based on information related to selected HVAC devices 120 and the HVAC power scheduler 322, at operation 408. The restricted HVAC schedule defines a control schedule of one or more of the HVAC devices 120 to be ON (i.e., selected HVAC devices 120) and is employed to selectively control the one or more HVAC devices 120 at a restricted power load that is less than the unrestricted power load to have at least one of the HVAC devices 120 controlled at a restricted power limit. Stated differently, the restricted HVAC schedule identifies when a selected HVAC device is ON and if applicable, a power mode of the HVAC device, where at least one of the HVAC devices 120 is operating at a restricted power level so that the total power load as defined by the restricted HVAC schedule is less than the unrestricted power load.

In one form, the HVAC power scheduler 322 defines a restricted HVAC schedule using a staggered activation-deactivation approach, a reduced power limit approach, or a combination thereof. In addition, the HVAC power scheduler 322 uses various inputs for defining the restricted HVAC schedule, where the inputs may include, but are not limited to: HVAC schedule 220, zone association of each selected HVAC device(s) 120, house zone prioritizations, power limit of each selected HVAC device 120, and/or a power rate for current time and day. In one form, the HVAC power scheduler 322 is provided as a series of conditions and/or algorithms that take the inputs, the V2B threshold, and/or the house load, to define the restricted HVAC schedule such that additional power is not drawn from the power grid or is limited to a selected power level.

For the staggered activation-deactivation approach, the selected HVAC devices are turned ON-OFF one at a time to have only one selected HVAC device 120 drawing power from the EV 110 at a time. The duration of each ON-time may be an estimated time based on various factors, such as but not limited to, a time period it takes to reach a HVAC setpoint, amount of power being consumed per hour be the selected HVAC device 120, and/zone priority of the house 102. For example, if one of the selected HVAC devices 120 is employed for a high priority zone, the HVAC power scheduler 322 defines the restricted HVAC schedule so that the HVAC device 120 associated with the high priority zone is turned ON first and stays on until the HVAC setpoint for the zone is satisfied, and once it is satisfied, the associated HVAC device 120 is turned OFF, and the other selected HVAC device 120 is (are) selectively activated based on a prioritization of the zone the selected HVAC device 120 is associated with.

For the reduced power limit approach, at least one of the selected HVAC devices 120 is a variable power device that is operable in multiple power modes, and the restricted HVAC schedule has the variable power device operate at lower power mode, as the restricted power limit. That is, if there are two selected HVAC devices with one being a variable power device, the HVAC power scheduler 322 defines a restricted HVAC schedule in which the variable power HVAC device 120 operates at a low power mode and the other selected HVAC device 120 is ON as long as the total power is under the V2B threshold.

In some variations, the staggered activation-deactivation approach and the reduced power limit approach may be used together to define the restricted HVAC schedule. In a non-limiting example, three HVAC devices 120 are to be ON with one being a variable power HVAC device 120. Using the inputs and the HVAC power scheduler 322, the HLC module 304 identifies a first selected HVAC device 120 as being associated with a high priority zone and the second and third selected HVAC devices 120 as being with a low priority zone, where the third selected HVAC device 120 is a variable power HVAC device. The restricted HVAC schedule may have the first selected HVAC device 120 turn ON while the second and third selected HVAC devices 120 are OFF. After the HVAC setpoint is met, the third selected HVAC device 120 is turned-on at a low power mode and the second selected HVAC device is turned-on for defined period of time before being turned off and the first selected HVAC device 120 being turned-on.

Once defined, the HLC module 304 selectively controls the selected HVAC devices in accordance with the restricted HVAC schedule, at operation 410. In one form, the HLC module 304 may transmit messages to the S-HVAC system 200 indicating which HVAC device 120 is to be ON and OFF in accordance with the restricted HVAC schedule. In another form, the HLC module 304 may transmit the restricted HVAC schedule directly to the S-HVAC system 200.

In some variations, the HLC module 304 may revise the restricted HVAC schedule based on inputs from the user, which may be provided via the V2B software app. 330 and/or the S-HVAC system 200. In a non-limiting example, the user may override the restricted HVAC schedule by, for example, indicating a selected HVAC device to be ON even if power is to be drawn from the electric grid or that the HVAC schedule 220, which is an unrestricted schedule, is to be employed for controlling the HVAC devices 120 in lieu of the restricted HVAC schedule.

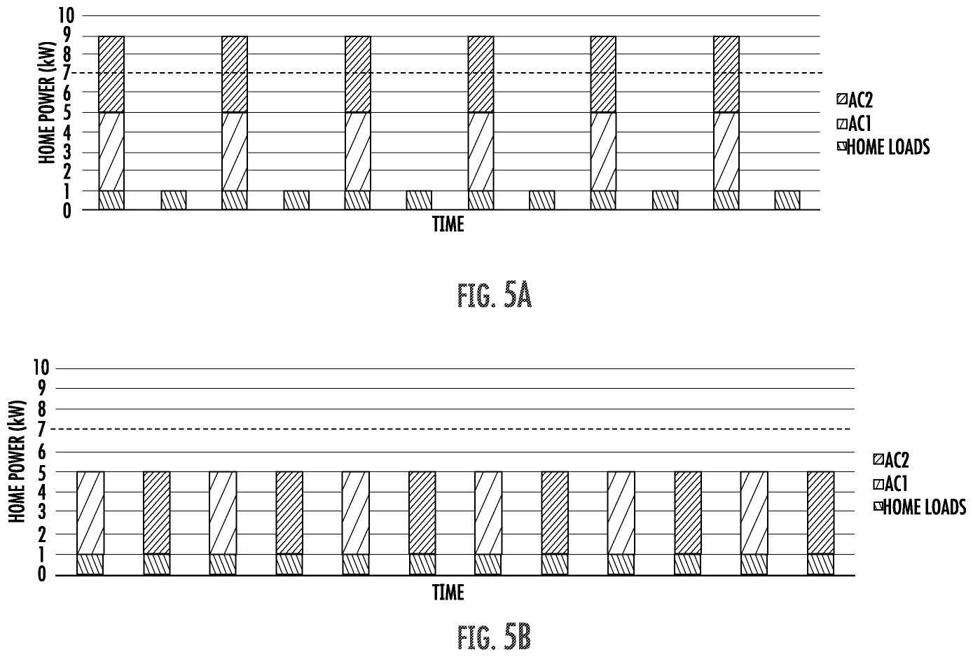

Referring to FIGS. 5A and 5B, an example of the power load of the house based on an unrestricted HVAC schedule and a restricted HVAC schedule, respectively. The unrestricted schedule illustrates that both AC units 120B, 120C are ON at desired times, and with the home load, the total power load of the house 102 may not be supported by the EV 110, and additional power may need to be drawn from the power grid 106. FIG. 5B illustrates the effect of a restricted HVAC schedule in which the AC units are staggered ON and Off such that total power load of the house 102 may be supported by the EV 110 and no additional power is drawn from the power grid 106.

The HVAC management routine 400 may be configured to perform other operations within the scope of the present disclosure, and should not be limited to the example described herein. For example, the routine 400 may determine whether power rates are at peak levels based on the time of day and/or data from the S-HVAC system 200. If the power rates are at non-peak levels, the routine 400 may control HVAC devices without restrictions (e.g., based on the HVAC schedule from S-HVAC system 200). If the power rates are at a peak level, the routine 400 next detects the unrestricted power load to determine if the load is less than or equal to the V2B threshold.

In yet another variation, the when the unrestricted power load is less than or equal to the V2B threshold, the V2B system may determine if additional power available from other non-grid sources such as the solar panels prior to defining the restricted HVAC schedule.

The present disclosure uses the word “home” and “house”, however, these words should not be read to limit the disclosure to a single family dwelling, and may also be applied to a number of other equivalent building, such as, but not limited to, a multi-family apartment building.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for supplying electrical power from a vehicle to a building having a heating, ventilation, air conditioning (HVAC) system, comprising:
detecting an unrestricted power load that is indicative of an unrestricted power output requested by the HVAC system having a plurality of HVAC devices; and
selectively controlling, in accordance with a restricted HVAC schedule defined in response to the unrestricted power load being greater than a vehicle-to-building (V2B) power threshold, one or more HVAC device from among the plurality of HVAC devices at a restricted power load that is less than the unrestricted power load to have at least one HVAC device from among the one or more HVAC devices controlled at a restricted power limit.

2. The method of claim 1, wherein:
the at least one HVAC device is a variable power device operable at a first power mode or a second power mode that uses less power than the first power mode, and
the at least one HVAC device is controlled in the second power mode as the restricted power limit.

3. The method of claim 1, wherein:
the one or more HVAC devices includes a first HVAC device and a second HVAC device, and
the restricted HVAC schedule defines a staggered activation-deactivation in which the first HVAC device and the second HVAC devices are turned ON-OFF one at a time to have only one of the first HVAC device or the second HVAC device drawing power from the vehicle for a selected time period.

4. The method of claim 1, wherein the plurality of HVAC devices includes at least one heat pump, at least one air-conditioning unit, or a combination thereof.

5. The method of claim 1, wherein the selectively controlling, in accordance with a restricted HVAC schedule defined in response to the unrestricted power load being greater than a vehicle-to-building (V2B) power threshold, the one or more HVAC devices further comprises transmitting a message to the HVAC system to turn the one or more HVAC devices ON-OFF in accordance with the restricted HVAC schedule.

6. The method of claim 1, wherein the detecting the unrestricted power load that is indicative of the unrestricted power output requested by the HVAC system further comprises estimating the unrestricted power output based on at least one of information associated with at least one of the HVAC devices among the plurality of HVAC devices, a HVAC setpoint, and a HVAC schedule.

7. The method of claim 1, wherein the restricted HVAC schedule is defined based on at least one of a zone prioritization, a building HVAC schedule, and a power limit of each HVAC device to be ON according to the building HVAC schedule.

8. A vehicle-to-building (V2B) system for supplying electrical power from a vehicle to a building having a heating, ventilation, air conditioning (HVAC) system, comprising:
one or more processors;
a memory storing instructions executable by the one or more processors to cause the one or more processors to:
detect an unrestricted power load that is indicative of an unrestricted power output requested by the HVAC system having a plurality of HVAC devices; and
selectively control, in accordance with a restricted HVAC schedule defined in response to the unrestricted power load being greater than a V2B power threshold, one or more HVAC device from among the plurality of HVAC devices at a restricted power load that is less than the unrestricted power load to have at least one HVAC device from among the one or more HVAC devices controlled at a restricted power limit.

9. The V2B system of claim 8, wherein:
the at least one HVAC device is a variable power device operable at a first power mode or a second power mode that uses less power than the first power mode, and
the at least one HVAC device is controlled in the second power mode as the restricted power limit.

10. The V2B system of claim 8, wherein:
the one or more HVAC devices includes a first HVAC device and a second HVAC device, and
the restricted HVAC schedule defines a staggered activation-deactivation in which the first HVAC device and the second HVAC devices are turned ON-OFF one at a time to have only one of the first HVAC device or the second HVAC device drawing power from the vehicle for a selected time period.

11. The V2B system of claim 8, wherein to selectively control, in accordance with a restricted HVAC schedule defined in response to the unrestricted power load being greater than a vehicle-to-building (V2B) power threshold, the one or more HVAC devices, the instructions further cause the one or more processors to transmit a message to the HVAC system to turn the one or more HVAC devices ON-OFF in accordance with the restricted HVAC schedule.

12. The V2B system of claim 8, wherein to detect the unrestricted power load, the instructions further cause the one or more processors to estimate the unrestricted power output based on at least one of information associated with at least one of the HVAC devices among the plurality of HVAC devices, a HVAC setpoint, and a HVAC schedule.

13. The V2B system of claim 8, wherein the restricted HVAC schedule is defined based on at least one of a zone prioritization, a building HVAC schedule, and a power limit of each HVAC device to be ON according to the building HVAC schedule.

14. A system comprising:
the V2B system of claim 8; and
a plurality of HVAC devices including at least one heat pump, at least one air-conditioning unit, or a combination thereof.

15. A non-transitory computer-readable medium comprising instructions for supplying power electrical power from a vehicle to a building having a heating, ventilation, air conditioning (HVAC) system that, when executed by a vehicle-to-building (V2B) system, cause the V2B system to perform operations including to:
detect an unrestricted power load that is indicative of an unrestricted power output requested by the HVAC system having a plurality of HVAC devices; and
selectively control, in accordance with a restricted HVAC schedule defined in response to the unrestricted power load being greater than a V2B power threshold, one or more HVAC device from among the plurality of HVAC devices at a restricted power load that is less than the unrestricted power load to have at least one HVAC device from among the one or more HVAC devices controlled at a restricted power limit.

16. The medium of claim 15, wherein:
the at least one HVAC device is a variable power device operable at a first power mode or a second power mode that uses less power than the first power mode, and
the at least one HVAC device is controlled in the second power mode as the restricted power limit.

17. The medium of claim 15, wherein:
the one or more HVAC devices includes a first HVAC device and a second HVAC device, and
the restricted HVAC schedule defines a staggered activation-deactivation in which the first HVAC device and the second HVAC devices are turned ON-OFF one at a time to have only one of the first HVAC device or the second HVAC device drawing power from the vehicle for a selected time period.

18. The medium of claim 15, further comprising instructions that, when executed by the V2B system to selectively control the one or more HVAC devices, cause the V2B system to transmit a message to the HVAC system to turn the one or more HVAC devices ON-OFF in accordance with the restricted HVAC schedule.

19. The medium of claim 15, further comprising instructions that, when executed by the V2B system to detect the unrestricted power load, cause the V2B system to estimate the unrestricted power output based on at least one of information associated with at least one of the HVAC devices among the plurality of HVAC devices, a HVAC setpoint, and a HVAC schedule.

20. The medium of claim 15, wherein the restricted HVAC schedule is defined based on at least one of a zone prioritization, a building HVAC schedule, and a power limit of each HVAC device to be ON according to the building HVAC schedule.
